(19) United States
(12) Patent Application Publication
(10) Pub. No.: US 2003/0141131 A1
(43) Pub. Date: Jul. 31, 2003

(54) Jet apparatus for injury prevention in motor vehicle

(76) Inventor: Chung Hwan Kim, Sungnam city (KR)

Correspondence Address: Law Office of Royal W Craig, 10 North Calvert Street Suite 153, Baltimore, MD, 21202, US

(21) Appl. No.: 10/258,631

(22) PCT Filed: Mar. 30, 2001
(86) PCT No.: PCT/KR01/00538

(30) Foreign Application Priority Data
Apr. 26, 2000 (KR) 2000/11866 U

(51) Int. Cl. B60R 21/00

(52) U.S. Cl. 180/282

(57) ABSTRACT

Disclosed is a jet apparatus for injury prevention in motor vehicle which is provided on a steering wheel, the front of a front seat and the backs of the driver's seat and the front seat for emitting the compressed air at the time of a sudden stop The jet apparatus for injury prevention comprises a jet nozzle provided on a steering wheel, the front of a front seat and the backs of a driver's seat and the front seat, for emitting compressed air therethrough, and an air tank for containing the compressed air to then be supplied to the jet nozzle when the motor vehicle is brought a sudden stop. According to this construction, th e compressed air is emitted from a steering wheel, the front of a front seat and the backs of a driver's seat and the front seat, for preventing the driver and passenger from inclining forward in the extreme and for functioning as another safety belt, when the upper part of the driver's body and the passenger s body abruptly inclines forward by a sudden brake of the vehicle.

### TECHNICAL FIELD

The present invention relates to a jet apparatus for injury prevention in a motor vehicle, and more particularly, to a jet apparatus for injury prevention in a motor vehicle which includes a jet nozzle provided at a steering wheel, the front of a front seat, and the backs of the driver's seat and the front seat, for emitting the compressed air of an air tank toward the driver's chest and the passenger's chest, thereby preventing the driver and passenger from inclining forward according to the Newton's Law of Inertia when the vehicle is brought to a sudden stop.

### BACKGROUND ART

In general, a driver and passengers incline forward according to the Newton's Law of Inertia when a vehicle is brought to a sudden stop owing to an unexpected accident. Then, the driver and the front seat passenger hit the steering wheel and the front of the front seat, respectively and the back seat passengers hit the backs of the driver's seat and the front seat.

To cope with such a situation, everyone should wear the safety belt on every trip, and an air bag is specially provided at the center part of the steering wheel around the driver's seat for protecting the driver from hitting hard surfaces like the steering wheel, a dashboard or the like at the time of a sudden brake.

As stated above, wearing the safety belt prevents the driver and passenger from spring forth during a collision. However, the safety belts press severely the driver's chest and the passenger's chest when the vehicle collides with each other or a stationary object at high speeds, which can cause a chest bruise, and serious injury or death. from suffocation. In particular, as the back seat passenger usually doesn't wear the safety belt, the back seat passenger's body abruptly inclines forward to then be collided with the back of the driver's seat or the front seat when the vehicle is brought to a sudden stop, which results in various injuries. Further, the air bag system protects only the driver except the front seat and back seat passengers, requires great expense and causes the driver to be suffocated when the driver's face is buried in the inflated air bag.

### DISCLOSURE OF INVENTION

To solve the above problems, it is an object of the present invention to provide a jet apparatus for injury prevention in a motor vehicle which includes a jet nozzle provided on a steering wheel, the front of a front seat, and the backs of the driver's seat and the front seat, for emitting the compressed air of an air tank toward passengers.

To achieve the above object, there is provided a jet apparatus for injury prevention in a motor vehicle, comprising a jet nozzle provided on a steering wheel, the front of a front seat and the backs of a driver's seat and the front seat, for emitting compressed air therethrough; and an air tank for containing the compressed air to then be supplied to the jet nozzle when the motor vehicle is brought to a sudden stop.

According to this construction, the compressed air is emitted from a steering wheel, the front of a front seat and the backs of a driver's seat and the front seat, for preventing a driver and a passenger from inclining forward in the extreme and for functioning as another safety belt, when the upper part of the driver's body and the passenger's body abruptly inclines forward by a sudden brake of the vehicle.

### BRIEF DESCRIPTION OF THE DRAWINGS

The above objective and advantages of the present invention will become more apparent by describing in detail a preferred embodiment thereof with reference to the attached drawings in which:

FIG. 1 is a schematic diagram explaining the operation of a jet apparatus for injury prevention in a motor vehicle according to the present invention.

### BEST MODE FOR CARRYING OUT INVENTION

Hereinbelow, a preferred embodiment of the present invention will be described.

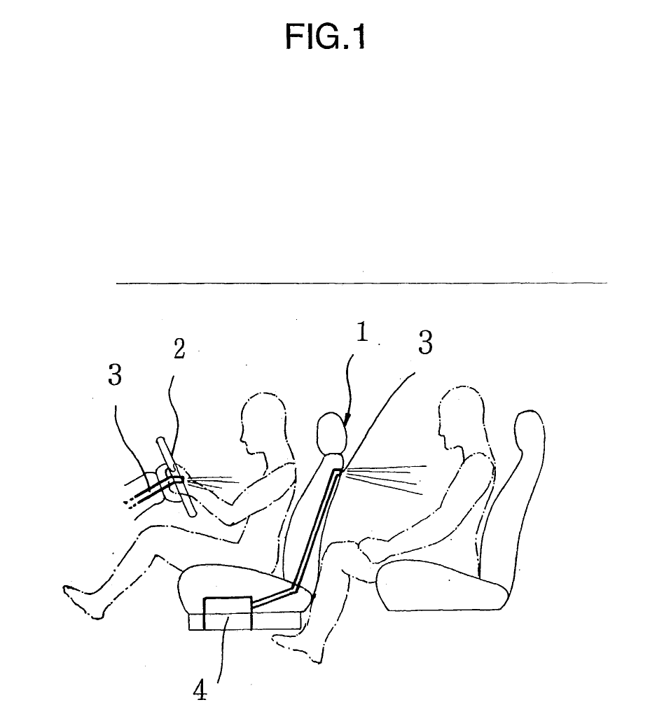

Referring to FIG. 1, the jet apparatus for injury prevention according to the present invention comprises a jet nozzle 3 provided on a steering wheel 2, the front (not shown) of a front seat and the backs of a driver's seat 1 and the front seat, for emitting the compressed of an air tank 4 toward passengers therethrough. Preferably, the air tank 4 connected to each jet nozzle 3 installed at the steering wheel and the front of the front seat is provided at the inner space of a dashboard, for emitting the compressed air toward the driver and the front seat passenger when the vehicle is brought to a sudden stop. Also, it is preferred that the air tank 4 connected to each jet nozzle 3. installed at the backs of the driver's seat and the front seat is provided at the inner space of the seats, for emitting the compressed air toward the rear seat passengers when the vehicle is brought to a sudden stop.

If the compressed air of the air tank 4 is emitted toward the driver's face or the passenger's face, the driver's neck or the passenger's neck may be injured owing to strong emission of the compressed air. Also, if the compressed air of the air tank 4 is emitted toward the lower part of the driver's body or the passenger's body, it is difficult to prevent the body from inclining forward. Accordingly, the jet nozzle 3 is preferably installed at a height of adult passenger's chest.

The operation of the jet apparatus for injury prevention constructed as above will now be explained.

When a driver brings to a sudden stop owing to an unexpected accident in the forward area, a control signal is applied from a controller (not shown) connected to a brake (not shown) to the air tank 4, so that the compressed air of the air tank 4 is emitted from the steering wheel 2, the front of the front seat and the backs of the driver's seat I and the front seat toward the driver and the passengers through the jet nozzle 3. Being compressed in the air tank 4, the air emitted from the jet nozzle 3 has a strong jet power.

Being emitted toward the driver's chest and the passenger's chest through the jet nozzle 3, the compressed air allows the upper part of the driver's body and the passenger's body not to incline forward according to the Newton's Law of Inertia when the vehicle is brought to a sudden stop. As a result, when the passengers don't wear the safety belts, the driver and the back seat passenger hits the steering wheel and the back of the driver's seat or the front seat, with a little shock, respectively, thereby preventing the driver and passenger from injuring seriously. When the passengers wear the safety belts, the compressed air emitted allows the driver's chest and the passenger's chest not to be pressed severely owing to the safety belt.

As described above, according to the present invention, the compressed air of the air tank is emitted from the steering wheel, the front of the front seat and the backs of the driver's seat and the front seat toward the driver's chest and the passenger's chest through the jet nozzle, when a driver brings to a sudden stop owing to an unexpected accident in the forward area. Therefore, the jet apparatus for injury invention allows the driver and passenger not to incline forward according to the Newton's Law of Inertia, thereby preventing the driver and passengers from hitting severely the steering wheel, the front of the front seat and the backs of the driver's seat and the front seat.

Industrial Applicability

In accordance with the present invention, the jet apparatus for injury prevention includes a jet nozzle provided on the steering wheel, the front of a front seat and the backs of a driver's seat and the front seat from which the compressed air of an air tank is emitted, for preventing the driver and passengers from inclining forward in the extreme and for functioning as another safety belt, when the vehicle is brought to a sudden brake.

What is claimed is:

1. A jet apparatus for injury prevention in a motor vehicle, comprising:
a jet nozzle provided on a steering wheel, the front of a front seat and the backs of a driver's seat and the front seat, for emitting compressed air therethrough; and
an air tank for containing the compressed air to then be supplied to the jet nozzle when the motor vehicle is brought to a sudden stop.
